(19) United States
(12) Patent Application Publication
(10) Pub. No.: US 2015/0234461 A1
(43) Pub. Date: Aug. 20, 2015

(54) DISPLAY CONTROL DEVICE, DISPLAY CONTROL METHOD AND RECORDING MEDIUM

(71) Applicant: SONY CORPORATION, Tokyo (JP)

(72) Inventors: SEIJI SUZUKI, KANAGAWA (JP); KAZUYUKI YAMAMOTO, KANAGAWA (JP); TAKURO NODA, TOKYO (JP); SAYAKA WATANABE, TOKYO (JP); EISUKE NOMURA, TOKYO (JP)

(21) Appl. No.: 14/615,735

(22) Filed: Feb. 6, 2015

(30) Foreign Application Priority Data
Feb. 18, 2014 (JP) 2014-028487

(51) Int. Cl. G06F 3/01; G06F 21/82; G02B 27/01

(52) U.S. Cl. CPC G06F 3/013; G02B 27/017; G06F 21/82

(57) ABSTRACT

Provided is a display control device including a display controller configured to display a predetermined image on a display part, a gaze detection part configured to detect a user's gaze, a determination part configured to determine whether to perform unlocking, based on a plurality of setting positions set to the predetermined image and a gaze while the predetermined image is displayed, and a calibration part configured to perform calibration of the gaze based on the gaze while the predetermined image is displayed.

### CROSS REFERENCE TO RELATED APPLICATIONS

This application claims the benefit of Japanese Priority Patent Application JP 2014-028487 filed Feb. 18, 2014, the entire contents of which are incorporated herein by reference.

### BACKGROUND

The present disclosure relates to a display control device, a display control method and a recording medium.

Recently, there has been developed a technique of detecting a user's gaze and performing processing according to the detection result. However, it is usual that the eye structure varies depending on the user. For example, it is usual that the eyeball size varies depending on the user. Moreover, the position relationship between the user's eyes and a device may change depending on the difference of the device used by the user. Therefore, there is a possibility that an error is caused in user gaze detection, and there has been also developed a technique for improving the accuracy of user gaze detection.

For example, there has been developed a technique of performing gaze calibration before user gaze detection is performed (for example, see JP 2009-183473A). In this calibration, the user is instructed to adjust the gaze to a predetermined direction, and the state of the eyes of the user whose gaze is adjusted according to the instruction is acquired. In that case, it is possible to add correction to the user gaze detection result according to the eye state acquired at the time of calibration.

### SUMMARY

However, generally, there is a possibility that the gaze calibration causes trouble for the user. Therefore, in the present disclosure, there is suggested a technique that can reduce the trouble caused for the user in performing the gaze calibration.

According to an embodiment of the present disclosure, there is provided a display control device including a display controller configured to display a predetermined image on a display part, a gaze detection part configured to detect a user's gaze, a determination part configured to determine whether to perform unlocking, based on a plurality of setting positions set to the predetermined image and a gaze while the predetermined image is displayed, and a calibration part configured to perform calibration of the gaze based on the gaze while the predetermined image is displayed.

According to another embodiment of the present disclosure, there is provided a display control method including displaying a predetermined image on a display part, detecting a user's gaze, determining whether to perform unlocking, based on a plurality of setting positions set to the predetermined image and a gaze while the predetermined image is displayed, and performing calibration of the gaze based on the gaze while the predetermined image is displayed.

According to another embodiment of the present disclosure, there is provided a non-transitory computer-readable recording medium having a program recorded therein, the program causing a computer to function as a display control device including a display controller configured to display a predetermined image on a display part, a gaze detection part configured to detect a user's gaze, a determination part configured to determine whether to perform unlocking, based on a plurality of setting positions set to the predetermined image and a gaze while the predetermined image is displayed, and a calibration part configured to perform calibration of the gaze based on the gaze while the predetermined image is displayed.

As described above, according to an embodiment of the present disclosure, it is possible to reduce trouble caused for the user in performing gaze calibration.

### BRIEF DESCRIPTION OF THE DRAWINGS

FIG. 1 is a diagram to describe the outline of a display control device and information processing apparatus according to an embodiment of the present disclosure;

FIG. 2 is a diagram illustrating a functional configuration example of a display control device according to an embodiment of the present disclosure;

FIG. 3 is a diagram illustrating a functional configuration example of an information processing apparatus according to an embodiment of the present disclosure;

FIG. 4 is a diagram to describe the setting of a plurality of setting positions with respect to an image;

FIG. 5 is a diagram to describe one example of processing applied to an image;

FIG. 6 is a flowchart illustrating one example of processing applied to an image;

FIG. 7 is a diagram to describe another example of processing applied to an image;

FIG. 8 is a flowchart illustrating another example of processing applied to an image;

FIG. 9 is a diagram to describe unlocking determination and gaze calibration;

FIG. 10 is a flowchart illustrating an example of unlocking determination and gaze calibration;

FIG. 11 is a diagram illustrating a hardware configuration example of a display control device according to an embodiment of the present disclosure; and

FIG. 12 is a diagram illustrating a hardware configuration example of an information processing apparatus according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in this specification and the appended drawings, there are some cases where a plurality of structural elements that have substantially the same function and structure are distinguished from one another by being denoted with different alphabets after the same reference numeral. Note that, in the case where it is not necessary to distinguish the plurality of structural elements that have substantially the same function and structure from one another, the plurality of structural elements are denoted with the same reference numeral only.

Moreover, the “DETAILED DESCRIPTION OF THE EMBODIMENT” is described according to the following item order:

### 1. Embodiment

1-1. Outline of display control device and information processing apparatus
1-2. Functional configuration example of display control device
1-3. Functional configuration example of information processing apparatus
1-4. Setting of plurality of setting positions with respect to image
1-5. Unlocking determination and gaze calibration
1-7. Hardware configuration example

### 2. Conclusion

### 1. EMBODIMENT

### 1-1. Outline of Display Control Device and Information Processing Apparatus

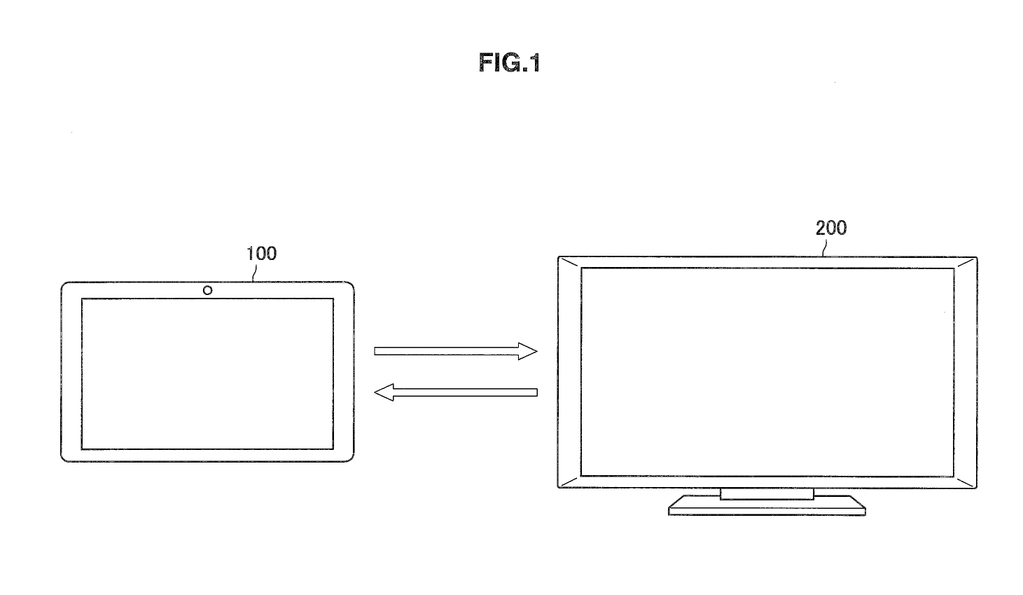

First, the outline of a display control device 100 and information processing apparatus 200 according to an embodiment of the present disclosure is described. FIG. 1 is a diagram to describe the outline of the display control device 100 and the information processing apparatus 200 according to an embodiment of the present disclosure. Referring to FIG. 1, the display control device 100 and the information processing apparatus 200 that can perform communication with each other are illustrated.

The form of communication between the display control device 100 and the information processing apparatus 200 is not especially limited, and may be wireless communication or may be wired communication. Moreover, in the example illustrated in FIG. 1, the display control device 100 and the information processing apparatus 200 are separately formed, but the display control device 100 and the information processing apparatus 200 may be integrated.

Recently, there has been developed a technique of detecting a user's gaze and performing processing according to the detection result. However, it is usual that the eye structure varies depending on the user. For example, it is usual that the eyeball size varies depending on the user. Moreover, the position relationship between the user's eyes and a device may change depending on the difference of the device used by the user. Therefore, there is a possibility that an error is caused in user gaze detection, and there has been also developed a technique for improving the accuracy of user gaze detection.

For example, there has been developed a technique of performing gaze calibration before user gaze detection is performed. In this calibration, the user is instructed to adjust the gaze to a predetermined direction, and the state of the eyes of the user whose gaze is adjusted according to the instruction is acquired. In that case, it is possible to add correction to the user gaze detection result according to the eye state acquired at the time of calibration.

However, generally, there is a possibility that the gaze calibration causes trouble for the user. Therefore, in this specification, there is suggested a technique that can reduce the trouble caused for the user in performing the gaze calibration. Specifically, whether to perform unlocking based on a plurality of setting positions set to an image and the gaze during the display of the image is determined, and gaze calibration is performed on the basis of the gaze during the display of the image.

Here, in the following explanation, a case where the display control device 100 is applied to a tablet terminal with a camera function is described as an example, but the display control device 100 may be applied to other apparatuses than the tablet terminal. For example, the display control device 100 may be applied to a video camera, a digital camera, personal digital assistants (PDA), a personal computer (PC), a smartphone, a mobile phone, a portable music player, a portable video processing apparatus, a portable game machine, a television apparatus and a digital signage, and so on.

Moreover, in the following explanation, a case where the information processing apparatus 200 is applied to a personal computer (PC) is described as an example, but the information processing apparatus 200 may be applied to other apparatuses than the personal computer (PC). For example, the information processing apparatus 200 may be applied to a video camera, a digital camera, Personal Digital Assistants (PDA), a tablet terminal, a smartphone, a mobile phone, a portable music player, a portable video processing apparatus, a portable game machine, a television apparatus and a digital signage, and so on.

The outline of the display control device 100 and the information processing apparatus 200 according to an embodiment of the present disclosure has been described above.

### 1-2. Functional Configuration Example of Display Control Device

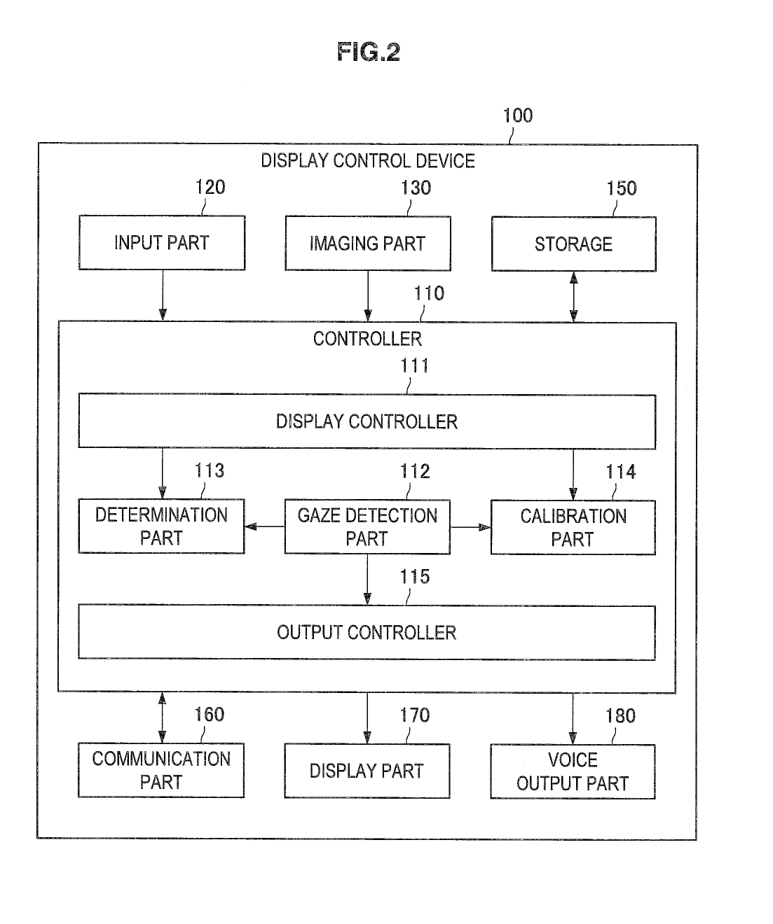

Subsequently, a functional configuration example of the display control device 100 according to an embodiment of the present disclosure is described. FIG. 2 is a diagram illustrating a functional configuration example of the display control device 100 according to an embodiment of the present disclosure. As shown in FIG. 2, the display control device 100 includes a controller 110, an input part 120, an imaging part 130, a storage 150, a communication part 160, a display part 170 and an audio output part 180.

For example, the controller 110 corresponds to a processor such as a central processing unit (CPU) and a digital signal processor (DSP). The controller 110 fulfills various functions held by the controller 110 by executing a program stored in the storage 150 or other storage media. The controller 110 has each functional block such as a display controller 111, a gaze detection part 112, a determination part 113, a calibration part 114 and an output controller 115. The functions of these functional blocks are described later.

The imaging part 130 is a camera module that takes an image. The imaging part 130 takes an image of the real space by the use of an imaging element such as a charge coupled device (CCD) and a complementary metal oxide semiconductor (CMOS), and generates an image. The image generated by the imaging part 130 is output to the controller 110. Here, the imaging part 130 is integrated with the display control device 100 in the example illustrated in FIG. 2, but the imaging part 130 may be formed separately from the display control device 100. For example, an imaging apparatus connected with the display control device 100 by wire or wireless may be handled as the imaging part 130.

The input part 120 detects and outputs operation by the user to the controller 110. In this specification, since a case is assumed where the input part 120 includes a touch panel, the operation by the user corresponds to operation to tap the touch panel. However, the input part 120 may include hardware (such as a button) other than the touch panel. Here, in the example illustrated in FIG. 2, the input part 120 is integrated with the display control device 100, but the input part 120 may be formed separately from the display control device 100.

The storage 150 stores a program for causing the controller 110 to operate by using a storage medium such as semiconductor memory or a hard disk. Further, for example, the storage 150 can also store various types of data (for example, an image) that are used by the program. Note that, in the example shown in FIG. 2, although the storage 150 is provided in an integrated manner with the display control device 100, the storage 150 may also be provided separately from the display control device 100.

The communication part 160 can communicate with the information processing apparatus 200. The communication scheme of the communication part 160 is not particularly limited, and the communication performed by the communication part 160 may be via radio or wire. Note that, in the example shown in FIG. 2, although the communication part 160 is provided in an integrated manner with the display control device 100, the communication part 160 may also be provided separately from the display control device 100.

The display part 170 displays various kinds of information according to control by the display controller 111. For example, the display part 170 includes a liquid crystal display (LCD) and an organic electroluminescence (EL) display device, and so on. Here, in the example illustrated in FIG. 2, the display part 170 has been integrated with the display control device 100, but the display part 170 may be formed separately from the display control device 100. For example, a display device connected with the display control device 100 by wire or wireless may be handled as the display part 170.

The audio output part 180 outputs audio according to control by the controller 110. For example, the audio output part 180 may include a speaker and a headphone, and so on. Here, in the example illustrated in FIG. 2, the audio output part 180 is integrated with the display control device 100, but the audio output part 180 may be formed separately from the display control device 100. The functional configuration example of the display control device 100 according to an embodiment of the present disclosure has been described above.

### 1-3. Functional Configuration Example of Information Processing Apparatus

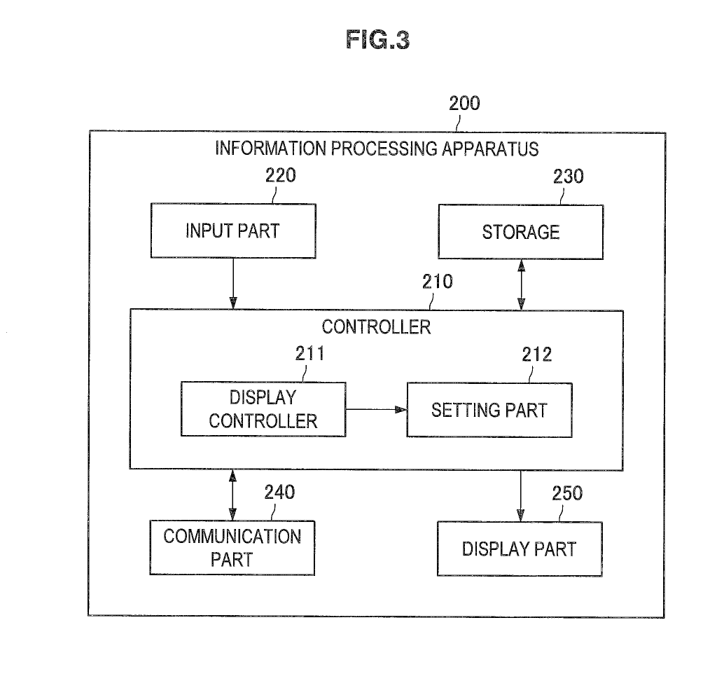

Subsequently, a functional configuration example of the information processing apparatus 200 according to an embodiment of the present disclosure is described. FIG. 3 is a diagram illustrating a functional configuration example of the information processing apparatus 200 according to an embodiment of the present disclosure. As illustrated in FIG. 3, the information processing apparatus 200 includes a controller 210, an input part 220, a storage 230, a communication part 240 and a display part 250.

For example, the controller 210 corresponds to a processor such as a central processing unit (CPU) and a digital signal processor (DSP). The controller 210 fulfills various functions held by the controller 210 by executing a program stored in the storage 230 or other storage media. The controller 210 has each functional block such as a display controller 211 and a setting part 212. The functions of these functional blocks are described later.

The input part 220 detects and outputs operation by the user to the controller 210. In this specification, since a case is assumed where the input part 220 includes a touch panel, the operation by the user corresponds to operation to tap the touch panel. However, the input part 220 may include hardware (such as a button) other than the touch panel. Here, in the example illustrated in FIG. 3, the input part 220 is integrated with the information processing apparatus 200, but the input part 220 may be formed separately from the information processing apparatus 200.

The storage 230 stores a program to operate the controller 210 by the use of a storage medium such as a semiconductor memory and a hard disk. Moreover, for example, the storage 230 can store various kinds of data (such as an image) used by the program. Here, in the example illustrated in FIG. 3, the storage 230 is integrated with the information processing apparatus 200, but the storage 230 may be formed separately from the information processing apparatus 200.

The communication part 240 can perform communication with the display control device 100. The form of the communication by the communication part 240 is not especially limited, and the communication by the communication part 240 may be communication by wireless or communication by wire. Here, in the example illustrated in FIG. 3, the communication part 240 is integrated with the information processing apparatus 200, but the communication part 240 may be formed separately from the information processing apparatus 200.

The display part 250 displays various kinds of information according to control by the display controller 211. For example, the display part 250 includes a liquid crystal display (LCD) and an organic electroluminescence (EL) display device, and so on. Here, in the example illustrated in FIG. 3, the display part 250 is integrated with the information processing apparatus 200, but the display part 250 may be formed separately from the information processing apparatus 200. For example, a display device connected with the information processing apparatus 200 by wire or wireless may be handled as the display part 250.

A functional configuration example of the information processing apparatus 200 according to an embodiment of the present disclosure has been described above.

### 1-4. Setting of Plurality of Setting Positions with Respect to Image

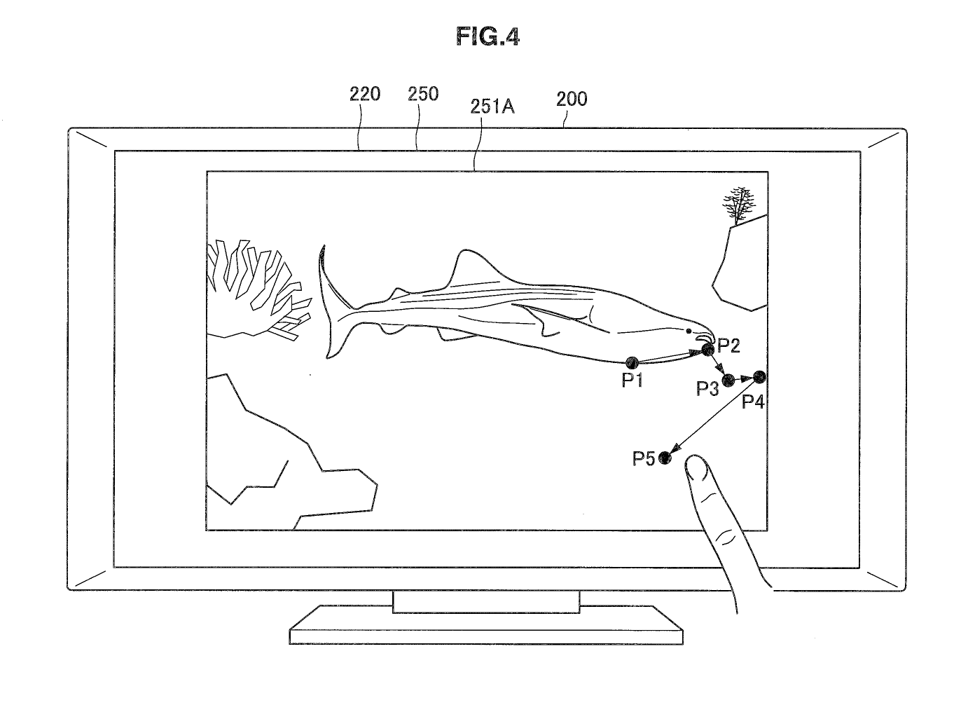

First, a plurality of setting positions are set with respect to an image by the information processing apparatus 200. In the following, the setting of the plurality of setting positions with respect to the image is described. FIG. 4 is a diagram to describe the setting of the plurality of setting positions with respect to the image. Referring to FIG. 4, in the information processing apparatus 200, the display controller 211 displays an image 251A on the display part 250. The image 251A may be any image.

When operation to sequentially select a plurality of desired positions in the image 251A is input in the input part 220, the plurality of positions are sequentially set by the setting part 212 as the plurality of setting positions. In the example illustrated in FIG. 4, since operation to sequentially select a plurality of desired positions P1 to P5 in the image 251A is input in the input part 220, setting positions P1 to P5 are sequentially set by the setting part 212. Here, a case is shown where the setting positions are specified by the user's operation, but they may be specified by the user's gaze. Therefore, the plurality of setting positions may be set on the basis of a position specified by the user's gaze or the user's operation in the image.

Here, FIG. 4 illustrates an example where five points of positions P1 to P5 are set as setting positions, but the number of setting positions is not especially limited as long as it is two or more. The plurality of setting positions set in this way are used for determination as to whether to perform unlocking and gaze calibration in the display control device 100. Therefore, processing may be applied to the image such that a plurality of set setting positions are suitable for gaze calibration. In the following, an example of processing applied to an image is described.

For example, in a case where the bias degree of the plurality of setting positions exceeds the upper limit value, there is a possibility that the accuracy of gaze calibration does not improve. Then, processing may include at least processing to expand the partial or entire region of the image. Specifically, the setting part 212 may apply processing to an image according to the bias degree of the plurality of setting positions. For example, in a case where the bias degree of the plurality of setting positions exceeds the upper limit value, the setting part 212 only has to apply processing to a region in which the plurality of setting positions exist.

To be more specific, in a case where the bias degree of setting positions in the horizontal direction exceeds the upper limit value, the setting part 212 may perform processing to expand the region in which the plurality of setting positions exist in the horizontal direction of the image. Alternatively, in a case where the bias degree in the vertical direction exceeds the upper limit value, the setting part 212 may perform processing to expand a region in which the plurality of setting positions exist in the vertical direction of the image. If such image expansion is performed, the bias of setting positions is reduced, and an image more suitable for gaze calibration may be generated.

The expansion processing of the partial or entire region of the image may be performed in any way. For example, processing may include at least processing to expand the partial or entire region of the image by seam carving. If the processing to perform expansion by seam carving is performed, the bias of setting positions is reduced more certainly, and an image more suitable for gaze calibration may be generated.

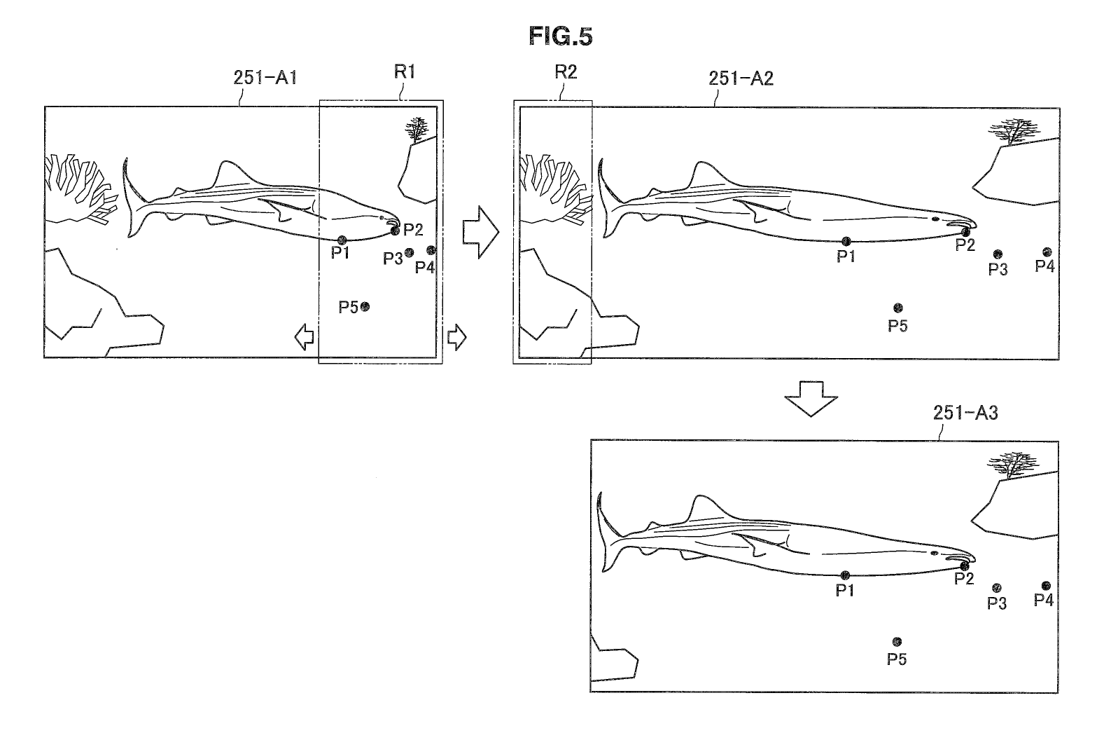

FIG. 5 is a diagram to describe one example of processing applied to an image. Referring to FIG. 5, an image 251-A1 is illustrated. Setting positions P1 to P5 are set in the image 251-A1. However, setting positions P1 to P5 are biased in the horizontal direction, and there is a possibility that it is not suitable for gaze calibration. In the example illustrated in FIG. 5, when detecting that the bias degree in the horizontal direction of setting positions P1 to P5 in the image 251-A1 exceeds the upper limit value, the setting part 212 detects a region R1 in which setting positions P1 to P5 exist, and performs processing to expand the region R1 in the horizontal direction by seam carving. When referring to FIG. 5, the setting part 212 generates an image 251-A2 expanding the region R1 in the horizontal direction.

Moreover, the processing may include at least processing to cut off a partial region of an image. For example, in a case where the bias degree of the setting positions exceeds the upper limit value, the setting part 212 may perform processing to cut off a region in which the setting positions do not exist, from the image. If such image cut-off is performed, the bias of the setting positions is reduced, and an image more suitable for gaze calibration may be generated.

When referring to FIG. 5, setting positions P1 to P5 are set in the image 251-A2. However, setting positions P1 to P5 are still biased in the horizontal direction, and there is a possibility that it is not suitable for gaze calibration. The setting part 212 detects a region R2 in which none of the setting positions P1 to P5 exists from the image 251-A2, and performs processing to cut the region R2. Referring to FIG. 5, the setting part 212 generates an image 251-A3 in which the region R2 is cut off.

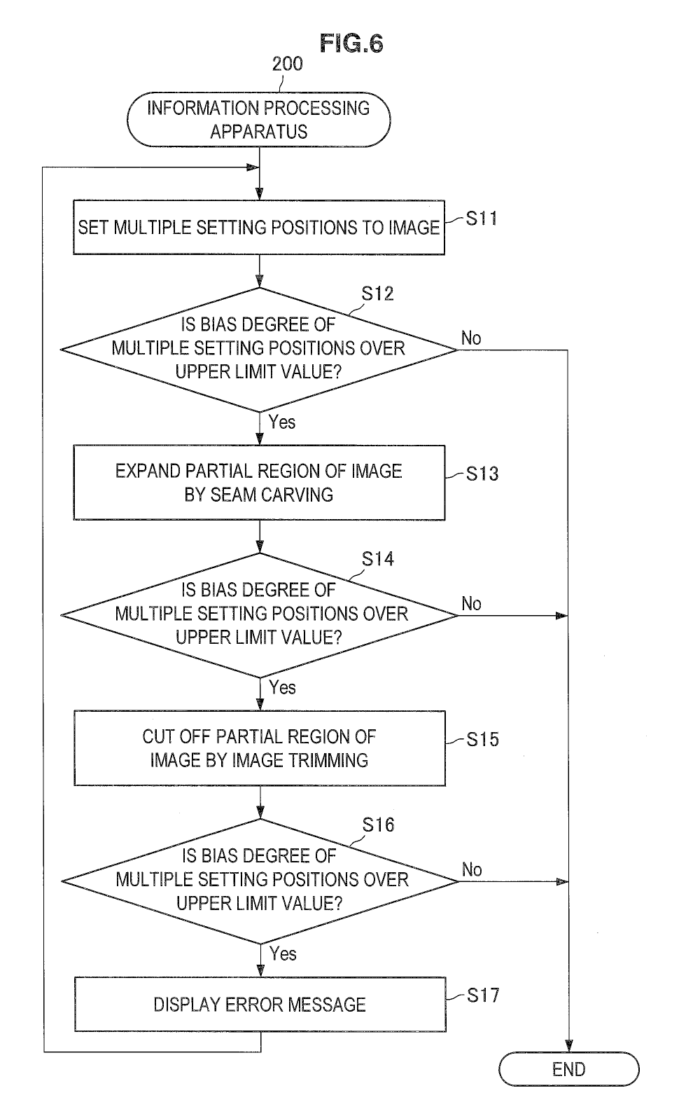

FIG. 6 is a flowchart illustrating one example of processing applied to an image. Here, the flowchart illustrated in FIG. 6 merely shows one example of processing applied to an image. Therefore, processing applied to an image is not limited to the example shown by the flowchart illustrated in FIG. 6.

First, the setting part 212 sets a plurality of setting positions to an image (S11). In a case where the bias degree of the plurality of setting positions does not exceed the upper limit value (“No” in S12), the setting part 212 ends operation. On the other hand, in a case where the bias degree of the plurality of setting positions exceeds the upper limit value (“Yes” in S12), the setting part 212 expands a partial region of the image by seam carving (S13). In addition, in a case where the bias degree of the plurality of setting positions does not exceed the upper limit value (“No” in S14), the setting part 212 ends operation. On the other hand, in a case where the bias degree of the plurality of setting positions exceeds the upper limit value (“Yes” in S14), the setting part 212 cuts off a partial region of the image by image trimming (S15).

Subsequently, in a case where the bias degree of the plurality of setting positions does not exceed the upper limit value (“No” in S16), the setting part 212 ends operation. On the other hand, in a case where the bias degree of the plurality of setting positions exceeds the upper limit value (“Yes” in S16), the setting part 212 displays an error message on the display part 250 (S17) and urges the re-input of the setting positions. Afterward, the controller 210 shifts operation to S11.

An example where processing is applied to an image has been described above, but other techniques may be adopted as a technique to reduce the bias degree of setting positions. For example, when positions are specified in an image to disperse the setting positions specified by the user, the display controller 211 may perform scroll display of the image.

A technique to reduce the bias degree of setting positions has been described above as an example of processing applied to an image. However, processing applied to an image is not limited to this example. For example, in the display control device 100 that performs gaze calibration, there is a possibility that the form of an image does not correspond to the form of a display region of the image in the display part 170.

For example, there is a case where the aspect ratio is different between the display region of the image in the display part 170 and the image. For example, in a case where the direction of the identical image is changed according to the direction of the display region of the image (for example, in a case where the display region is set in a vertically long manner or the display region is set in a horizontally long manner, and so on) and display is performed, a situation in which the form of the image does not correspond to the form of the display region may happen. Therefore, as an example of processing applied to an image, an example of applying processing to an image according to the form of the image display region in the display part 170 is described.

For example, the setting part 212 may apply processing to an image according to the form of the image display region in the display part 170. To be more specific, in a case where the form of the image does not match the form of the image display region in the display part 170, the setting part 212 may perform processing to expand the partial or entire region of the image. If such image expansion is performed, since an image of a form matching the form of the image display region in the display part 170 may be generated, an image more suitable for gaze calibration may be generated.

Expansion processing of the partial or entire region of the image may be performed in any way. For example, processing may include at least processing to expand the partial or entire region of the image by seam carving. If expansion processing by seam carving is performed, an image more suitable for gaze calibration may be generated while reducing the bias of setting positions.

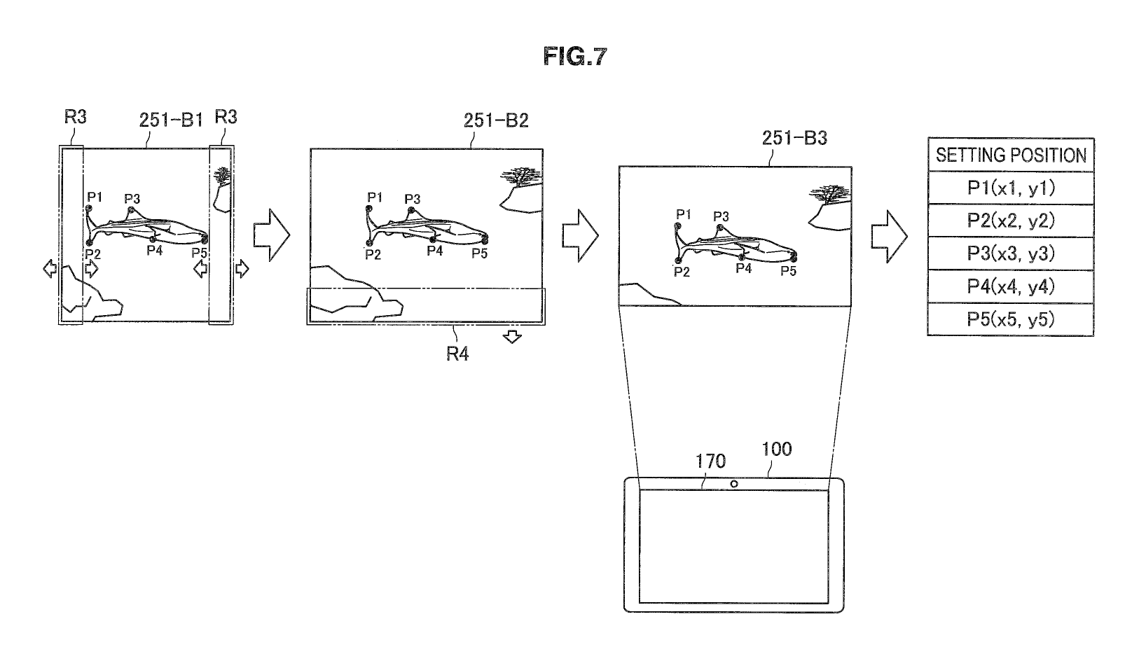

FIG. 7 is a diagram to describe another example of processing applied to an image. Referring to FIG. 7, an image 251-B1 is illustrated. Setting positions P1 to P5 are set to the image 251-B1. However, the form of the image 251-B1 does not match the form of the display region of the display part 170 of the display control device 100, and there is a possibility that it is not suitable for gaze calibration. In the example illustrated in FIG. 7, the setting part 212 detects a region R3 in which none of the setting positions P1 to P5 exists from the image 251-B1, and performs processing to expand the region R3 in the horizontal direction by seam carving. Referring to FIG. 7, the setting part 212 generates an image 251-B2 expanding the region R3 in the horizontal direction.

Moreover, processing may include at least processing to cut off a partial region of an image. For example, in the case of detecting a region in which a setting position does not exist, the setting part 212 may perform processing to cut off the detected region from the image. If such image cut-off is performed, an image more suitable for gaze calibration may be generated while reducing the bias of setting positions.

Referring to FIG. 7, setting positions P1 to P5 are set to an image 251-B2. However, the form of the image 251-B2 does not match the form of the display region of the display part 170 of the display control device 100 yet, and there is a possibility that it is not suitable for gaze calibration. The setting part 212 detects a region R4 in which the setting positions do not exist from the image 251-B2, and performs processing to cut off the region R4. Referring to FIG. 7, the setting part 212 generates an image 251-B3 in which the region R4 is cut off.

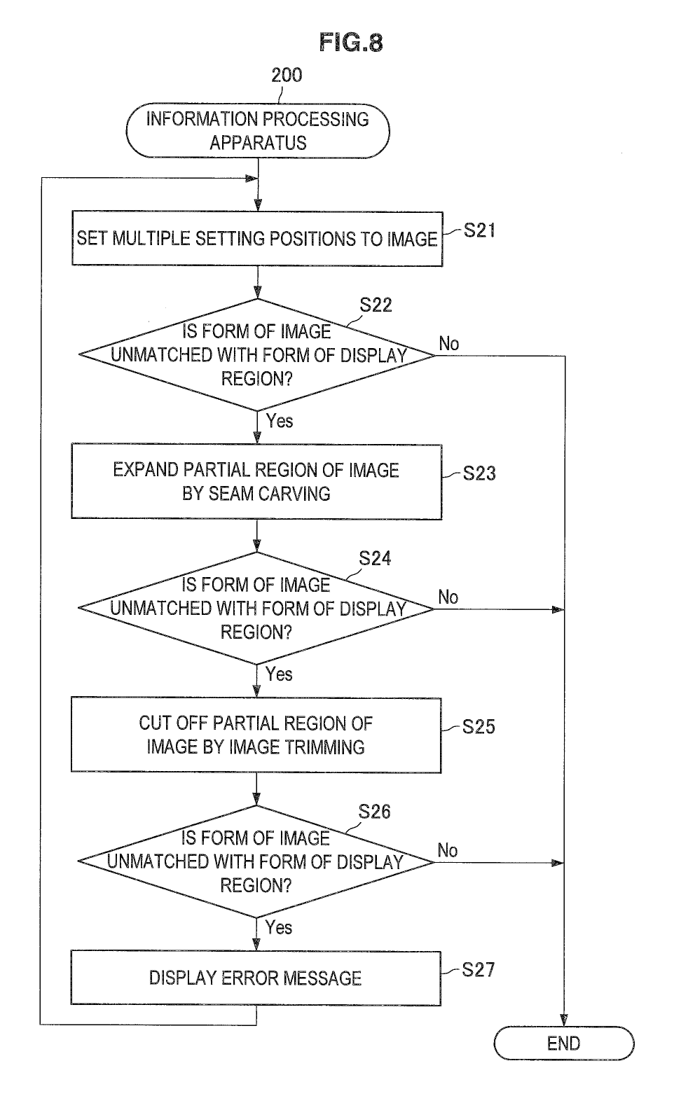

FIG. 8 is a flowchart illustrating another example of processing applied to an image. Here, the flowchart illustrated in FIG. 8 merely shows one example of processing applied to an image. Therefore, processing applied to an image is not limited to the example shown by the flowchart illustrated in FIG. 8.

The setting part 212 sets a plurality of setting positions to an image (S21). In a case where the form of the image matches the form of the display region of the display part 170 (“No” in S22), the setting part 212 ends operation. On the other hand, in a case where the form of the image is unmatched with the form of the display region of the display part 170 (“Yes” in S22), the setting part 212 expands a partial region of the image by seam carving (S23). In addition, in a case where the form of the image matches the form of the display region of the display part 170 (“No” in S24), the setting part 212 ends operation. On the other hand, in a case where the form of the image is unmatched with the form of the display region of the display part 170 (“Yes” in S24), the setting part 212 cuts off a partial region of the image by image trimming (S25).

Subsequently, in a case where the form of the image matches the form of the display region of the display part 170 (“No” in S26), the setting part 212 ends operation. On the other hand, in a case where the form of the image is unmatched with the form of the display region of the display part 170 (“Yes” in S26), the setting part 212 displays an error message on the display part 250 (S27) and urges the re-input of the setting positions. Afterward, the controller 210 shifts operation to S21.

The setting of a plurality of setting positions with respect to an image has been described above. As mentioned above, a plurality of setting positions set in this way are used for determination as to whether to perform unlocking in the display control device 100 and for gaze calibration.

### 1-5. Unlocking Determination and Gaze Calibration

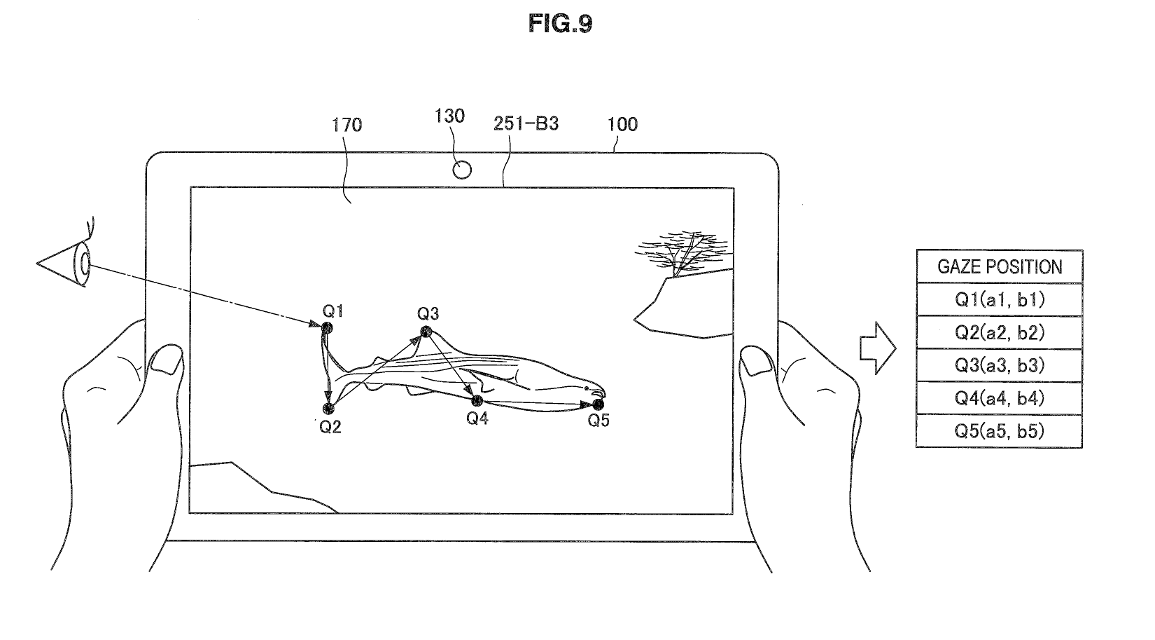

Subsequently, unlocking determination and gaze calibration are described. FIG. 9 is a diagram to describe the unlocking determination and the gaze calibration. In the display control device 100, the display controller 111 displays an image to which a plurality of setting positions are set as mentioned above, on the display part 170. For example, the display controller 111 may display a processed image provided by applying processing to an image, on the display part 170. In FIG. 9, the display controller 111 displays the image 251-B3 on the display part 170, and a plurality of setting positions P1 to P5 are set to this image 251-B3. It is in a state where the lock is applied while the image 251-B3 is displayed on the display part 170. In a state where the lock is applied, screen transition to the next screen is not performed. The next screen may include a screen displayed at the time of restoration from a sleep state and a screen initially displayed when power is supplied.

The gaze detection part 112 detects the user's gaze. A technique of user gaze detection is not especially limited. For example, in a case where the user's eye region is imaged by the imaging part 130, the gaze detection part 112 may detect the user's gaze on the basis of an imaging result acquired by imaging the user's eye region. In a case where an infrared camera is used as the imaging part 130, an infrared irradiation device that irradiates the user's eye region with an infrared ray may be installed. Then, the infrared ray reflected by the user's eye region may be imaged by the imaging part 130.

Alternatively, in a case where a head mount display (HMD) is on the user's head, the gaze detection part 112 may detect the user's gaze on the basis of the direction of the HMD. Moreover, in a case where a myoelectric sensor is mounted to the user's body, the gaze detection part 112 may detect the user's gaze on the basis of myoelectricity detected by the myoelectric sensor.

The determination part 113 determines whether to perform unlocking on the basis of a plurality of setting positions set to an image and a gaze while the image is displayed. For example, the determination part 113 sequentially detects a plurality of gaze positions on the basis of the gaze while the image is displayed, and, in a case where a predetermined relationship is satisfied between corresponding positions in a plurality of gaze positions and a plurality of setting positions, may determine to perform unlocking. To be more specific, in a case where corresponding positions in a plurality of gaze positions and a plurality of setting positions are matched or close, the determination part 113 may determine to perform unlocking.

Setting positions P1 (x1, y1) to P5 (x5, y5) are set in the example illustrated in FIG. 7, and gaze positions Q1 (a1, b1) to Q5 (a5, b5) are detected in the example illustrated in FIG. 9. In each of combinations from a combination of setting positions P1 (x1, y1) and Q1 (a1, b1) to a combination of setting positions P5 (x5, y5) and Q5 (a5, b5), in a case where they are matched or close, the determination part 113 may determine to perform unlocking. Moreover, in a case where any combinations of all the combinations are not matched or close, the determination part 113 may not perform unlocking.

Moreover, it may be designed such that the user can recognize that a setting position and a gaze position are matched or close. For example, the output controller 115 may output predetermined audio from the audio output part 180 every time the gaze position is detected. Since it is hardly assumed that the user's gaze greatly deviates from the setting position when the user merely listens to the output sound, it is possible to effectively make the user recognize that the setting position and the gaze position are matched or close.

The calibration part 114 performs gaze calibration on the basis of gaze while an image is displayed. In the example illustrated in FIG. 9, the state of the user's eyes in a case where gaze positions Q1 to Q5 are gazed such that the gaze is sequentially adjusted to setting positions P1 to P5, is imaged by the imaging part 130. The calibration part 114 calculates the amount of correction performed on the result of user gaze detection, according to the eye state imaged by the imaging part 130. The amount of correction calculated by the calibration part 114 may be used to correct the gaze detected by the gaze detection part 112.

As mentioned above, the display control device 100 according to an embodiment of the present disclosure includes the determination part 113 that determines whether to perform unlocking, on the basis of a plurality of setting positions set to an image and a gaze while the image is displayed. Moreover, the display control device 100 according to an embodiment of the present disclosure includes the calibration part 114 that performs gaze calibration on the basis of the gaze while the image is displayed. According to such a configuration, by performing unlocking determination and gaze calibration in parallel, it is possible to reduce the trouble caused for the user when the gaze calibration is performed.

Moreover, according to such a configuration, by performing unlocking determination and gaze calibration in parallel, there may be provided an effect that it is possible to perform gaze calibration without making the user realize it. In addition, according to such a configuration, since a determination as to whether to perform unlocking is made on the basis of the user's gaze, it is possible to reduce a possibility that a code for unlocking is read by a surrounding person.

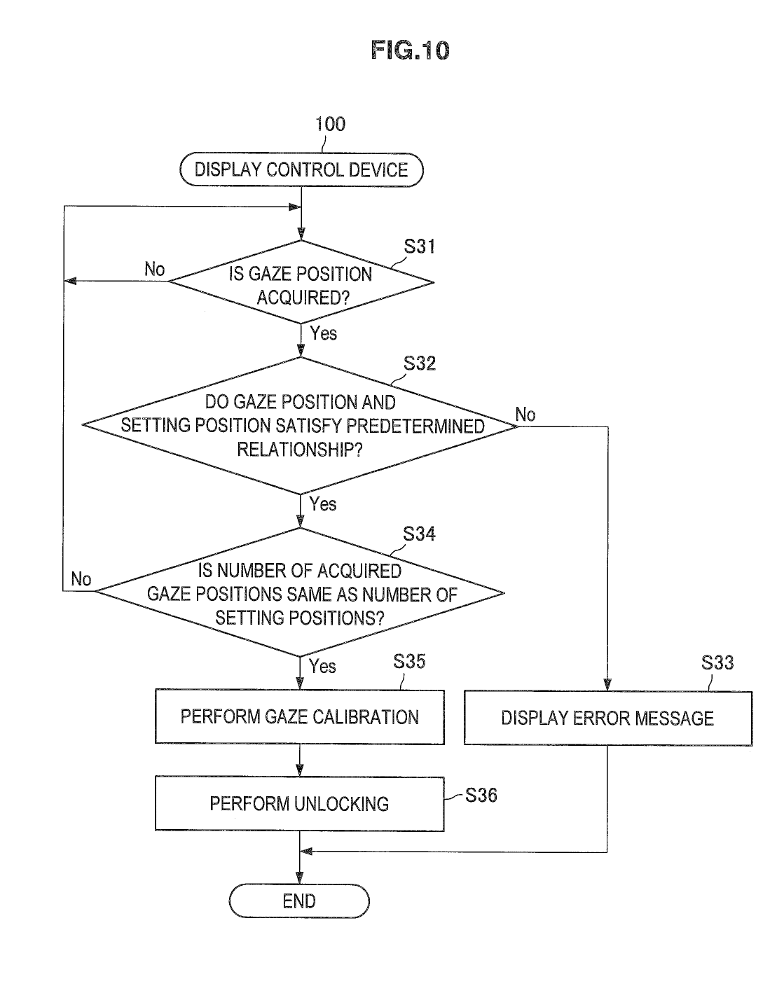

FIG. 10 is a flowchart illustrating an example of unlocking determination and gaze calibration. Here, the flowchart illustrated in FIG. 10 merely shows one example of the unlocking determination and gaze calibration. Therefore, the unlocking determination and the gaze calibration are not limited to the example shown by the flowchart illustrated in FIG. 10.

First, in a case where the gaze position is not acquired on the basis of the user's gaze (“No” in S31), the controller 110 shifts operation to S31. On the other hand, in a case where the gaze position is acquired on the basis of the user's gaze (“Yes” in S31), the controller 110 shifts operation to S32. In a case where the determination part 113 determines that the gaze position and the setting position do not satisfy a predetermined relationship (“No” in S32), the display controller 111 displays an error message on the display part 170 (S33) and ends operation. On the other hand, in the case of determining that the gaze position and the setting position satisfy the predetermined relationship (“Yes” in S32), the determination part 113 shifts operation to S34.

In the case of determining that the number of acquired gaze positions is the same as the number of setting positions (“No” in S34), the determination part 113 shifts operation to S31. On the other hand, in a case where the determination part 113 determines that the gaze positions corresponding to the number of setting positions are acquired (“Yes” in S34), the calibration part 114 performs gaze calibration (S35), and, when unlocking is performed (S36), it is shifted to operation after the unlocking.

### 1-7. Hardware Configuration Example

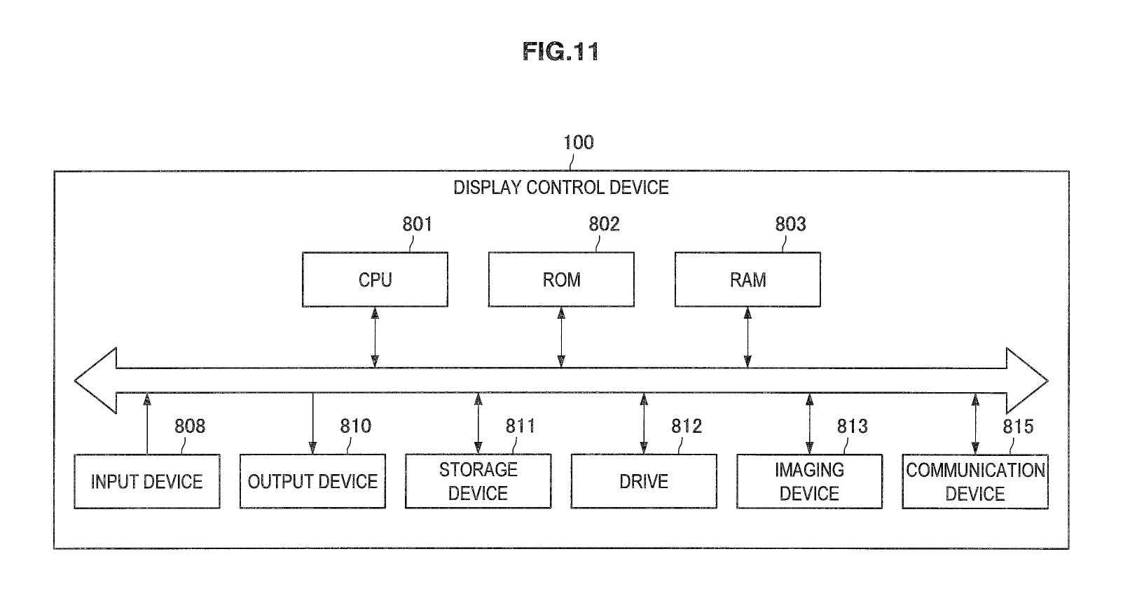

Next, a hardware configuration example of the display control device 100 according to the present embodiment of the present disclosure will be described. FIG. 11 is a diagram showing a hardware configuration example of the display control device 100 according to the present embodiment of the present disclosure. However, the hardware configuration example shown in FIG. 11 is merely an example of the hardware configuration of the display control device 100. Accordingly, the hardware configuration of the display control device 100 is not limited to the example shown in FIG. 11.

As illustrated in FIG. 11, the display control device 100 includes a central processing unit (CPU) 801, read only memory (ROM) 802, random access memory (RAM) 803, an input device 808, an output device 810, a storage device 811, a drive 812, an imaging device 813, and a communication device 815.

The CPU 801 functions as an arithmetic processing unit and a controller, and controls entire operation of the display control device 100 in accordance with various programs. Further, the CPU 801 may be a microprocessor. The ROM 802 stores a program, a calculation parameter, and the like used by the CPU 801. The RAM 803 temporarily stores a program used in execution of the CPU 801, a parameter varying as appropriate during the execution, and the like. They are connected with each other via a host bus configured from a CPU bus or the like.

The input device 808 is configured from, for example, an input part for inputting information by a user, such as a mouse, a keyboard, a touch panel, a button, a microphone, a switch, or a lever, and an input control circuit which generates an input signal based on the input by the user and outputs the generated input signal to the CPU 801. The user of the display control device 100 can input various kinds of data to the display control device 100 and can instruct the display control device 100 to perform a processing operation by operating the input device 808.

The output device 810 includes, for example, a display device such as a liquid crystal display (LCD) device, an organic light emitting diode (OLED) device, or a lamp. Further, the output device 810 includes an audio output device such as a speaker or headphones. For example, a display device displays an image that has been imaged or an image that has been generated. On the other hand, an audio output device converts audio data or the like into audio and outputs the audio.

The storage device 811 is a device for storing data configured as an example of a storage of the display control device 100. The storage device 811 may include, for example, a storage medium, a recording device for recording data in the storage medium, a reading device for reading out the data from the storage medium, and a deletion device for deleting the data recorded in the storage medium. The storage device 811 stores a program executed by the CPU 801 and various data.

The drive 812 is a reader/writer for the storage medium and is built in or externally attached to the display control device 100. The drive 812 reads out information recorded in a removable storage medium which is mounted thereto, such as a magnetic disk, an optical disc, a magneto-optical disk, or a semiconductor memory, and outputs the information to the RAM 803. Further, the drive 812 can also write information in the removable storage medium.

The imaging device 813 includes an imaging optical system such as an imaging lens or a zoom lens for condensing light, and a signal conversion device such as a charge coupled device (CCD) or a complementary metal oxide semiconductor (CMOS). The imaging optical system condenses light emitted from a subject and forms a subject image in a signal conversion part, and the signal conversion device converts the formed subject image into an electrical image signal.

The communication device 815 is a communication interface configured from a communication device or the like for establishing a connection with a network. In addition, the communication device 815 may be a wireless local area network (LAN) enabled communication device, a long term evolution (LTE) enabled communication device, or a wired communication device for performing wired communication. The communication device 815 is capable of communicating with another device through a network.

Heretofore, a hardware configuration example of the display control device 100 according to the present embodiment of the present disclosure has been described.

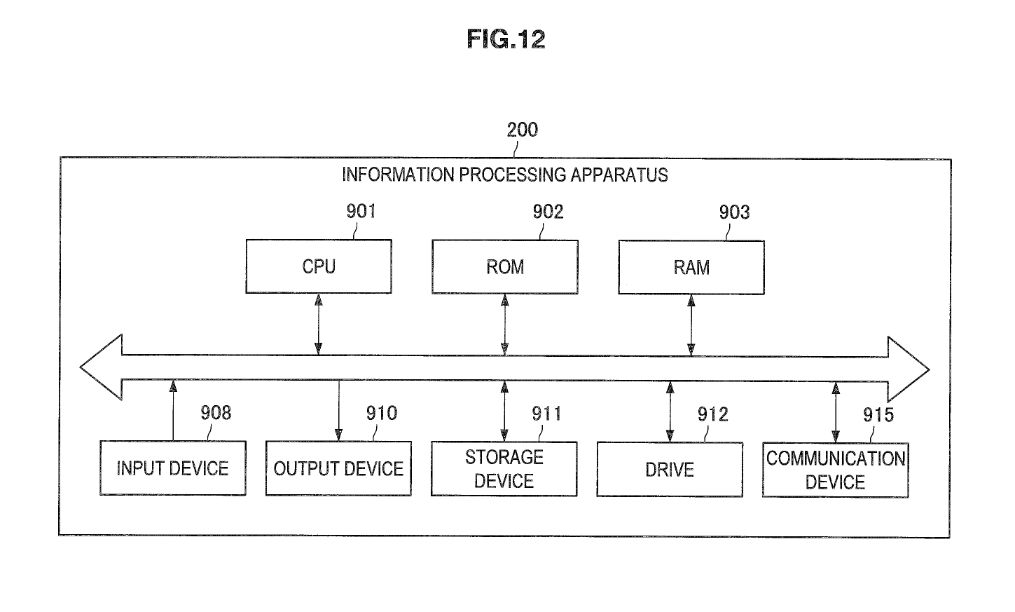

Next, a hardware configuration example of the information processing apparatus 200 according to the present embodiment of the present disclosure will be described. FIG. 12 is a diagram showing a hardware configuration example of the information processing apparatus 200 according to the present embodiment of the present disclosure. However, the hardware configuration example shown in FIG. 12 is merely an example of the hardware configuration of the information processing apparatus 200. Accordingly, the hardware configuration of the information processing apparatus 200 is not limited to the example shown in FIG. 12.

As illustrated in FIG. 12, the information processing apparatus 200 includes a central processing unit (CPU) 901, read only memory (ROM) 902, random access memory (RAM) 903, an input device 908, an output device 910, a storage device 911, a drive 912, and a communication device 915.

The CPU 901 functions as an arithmetic processing unit and a controller, and controls entire operation of the information processing apparatus 200 in accordance with various programs. Further, the CPU 901 may be a microprocessor. The ROM 902 stores a program, a calculation parameter, and the like used by the CPU 901. The RAM 903 temporarily stores a program used in execution of the CPU 901, a parameter varying as appropriate during the execution, and the like. They are connected with each other via a host bus configured from a CPU bus or the like.

The input device 908 is configured from, for example, an input part for inputting information by a user, such as a mouse, a keyboard, a touch panel, a button, a microphone, a switch, or a lever, and an input control circuit which generates an input signal based on the input by the user and outputs the generated input signal to the CPU 901. The user of the information processing apparatus 200 can input various kinds of data to the information processing apparatus 200 and can instruct the information processing apparatus 200 to perform a processing operation by operating the input device 908.

The output device 910 includes, for example, a display device such as a liquid crystal display (LCD) device, an organic light emitting diode (OLED) device, or a lamp. Further, the output device 910 includes an audio output device such as a speaker or headphones. For example, a display device displays an image that has been imaged or an image that has been generated. On the other hand, an audio output device converts audio data or the like into audio and outputs the audio.

The storage device 911 is a device for storing data configured as an example of a storage of the information processing apparatus 200. The storage device 911 may include, for example, a storage medium, a recording device for recording data in the storage medium, a reading device for reading out the data from the storage medium, and a deletion device for deleting the data recorded in the storage medium. The storage device 911 stores a program executed by the CPU 901 and various data.

The drive 912 is a reader/writer for the storage medium and is built in or externally attached to the display control device 100. The drive 912 reads out information recorded in a removable storage medium which is mounted thereto, such as a magnetic disk, an optical disc, a magneto-optical disk, or a semiconductor memory, and outputs the information to the RAM 903. Further, the drive 912 can also write information in the removable storage medium.

The communication device 915 is a communication interface configured from a communication device or the like for establishing a connection with a network. In addition, the communication device 915 may be a wireless local area network (LAN) enabled communication device, a long term evolution (LTE) enabled communication device, or a wired communication device for performing wired communication. The communication device 915 is capable of communicating with another device through a network.

Heretofore, a hardware configuration example of the information processing apparatus 200 has been described.

### 2. CONCLUSION

As described above, according to an embodiment of the present disclosure, there is provided the display control device 100 including: the display controller 111 configured to display a predetermined image on the display part 170; the gaze detection part 112 configured to detect a user's gaze; the determination part 113 configured to determine whether to perform unlocking on the basis of a plurality of setting positions set to a predetermined image and a gaze while the predetermined image is displayed; and the calibration part 114 configured to perform gaze calibration on the basis of the gaze while the predetermined image is displayed.

According to such a configuration, by performing unlocking determination and gaze calibration in parallel, it is possible to reduce the trouble caused for the user when the gaze calibration is performed. Moreover, according to such a configuration, by performing unlocking determination and gaze calibration in parallel, there may be provided an effect that it is possible to perform gaze calibration without making the user realize it. In addition, according to such a configuration, since a determination as to whether to perform unlocking is made on the basis of the user's gaze, it is possible to reduce a possibility that a code for unlocking is read by a surrounding person.

It should be understood by those skilled in the art that various modifications, combinations, sub-combinations and alterations may occur depending on design requirements and other factors insofar as they are within the scope of the appended claims or the equivalents thereof.

Moreover, it is possible to create a program to make hardware such as a CPU, a ROM and a RAM which are incorporated in a computer fulfill a function equivalent to components held by the above-mentioned display control device 100. Moreover, a computer-readable recording medium having the program recorded therein may be provided.

Moreover, it is possible to create a program to make hardware such as a CPU, a ROM and a RAM which are incorporated in a computer fulfill a function equivalent to components held by the above-mentioned information processing apparatus 200. Moreover, a computer-readable recording medium having the program recorded therein may be provided.

Additionally, the present technology may also be configured as below:

(1) A display control device including:

a display controller configured to display a predetermined image on a display part;

a gaze detection part configured to detect a user's gaze;

a determination part configured to determine whether to perform unlocking, based on a plurality of setting positions set to the predetermined image and a gaze while the predetermined image is displayed; and

a calibration part configured to perform calibration of the gaze based on the gaze while the predetermined image is displayed.

(2) The display control device according to (1), wherein the display controller displays a processed image provided by applying processing to the predetermined image, on the display part.
(3) The display control device according to (2), wherein the processing includes at least processing to expand a partial or entire region of the predetermined image.
(4) The display control device according to (3), wherein the processing includes at least processing to expand the partial or entire region of the predetermined image by seam carving.
(5) The display control device according to (3), wherein the processing includes at least processing to cut off the partial region of the predetermined image.
(6) The display control device according to any one of (1) to (5), wherein the display controller displays a processed image provided by applying processing to the predetermined image according to a bias degree of the plurality of setting positions, on the display part.
(7) The display control device according to any one of (2) to (5), wherein the display controller displays a processed image provided by applying processing to the predetermined image according to a form of a display region of the predetermined image, on the display part.
(8) The display control device according to any one of (1) to (7), wherein the plurality of setting positions are set based on a position specified by the user's gaze or a user's operation in the predetermined image.
(9) The display control device according to (8), wherein, when the position is specified in the predetermined image, the predetermined image is scrolled and displayed.
(10) The display control device according to any one of (1) to (9), wherein the determination part sequentially detects a plurality of gaze positions based on the gaze while the predetermined image is displayed, and, when corresponding positions in the plurality of gaze positions and the plurality of setting positions satisfy a predetermined relationship, determines to perform unlocking
(11) The display control device according to (10), wherein, when the corresponding positions in the plurality of gaze positions and the plurality of setting positions are matched or close, the determination part determined to perform unlocking
(12) The display control device according to (10) or (11), further including:

an output controller configured to output predetermined audio from an audio output part every time the gaze position is detected.

(13) The display control device according to any one of (1) to (12), wherein the gaze detection part detects the user's gaze based on an imaging result acquired by imaging the user's eye region.
(14) The display control device according to any one of (1) to (12), wherein the gaze detection part detects the user's gaze based on a direction of a head mount display (HMD) on the user's head.
(15) The display control device according to any one of (1) to (12), wherein the gaze detection part detects the user's gaze based on myoelectricity detected by a myoelectric sensor on a user's body.
(16) A display control method including:
displaying a predetermined image on a display part;
detecting a user's gaze;
determining whether to perform unlocking, based on a plurality of setting positions set to the predetermined image and a gaze while the predetermined image is displayed; and
performing calibration of the gaze based on the gaze while the predetermined image is displayed.
   (17) A non-transitory computer-readable recording medium having a program recorded therein, the program causing a computer to function as a display control device including:
a display controller configured to display a predetermined image on a display part;
a gaze detection part configured to detect a user's gaze;
a determination part configured to determine whether to perform unlocking, based on a plurality of setting positions set to the predetermined image and a gaze while the predetermined image is displayed; and
a calibration part configured to perform calibration of the gaze based on the gaze while the predetermined image is displayed.

What is claimed is:

1. A display control device comprising:
a display controller configured to display a predetermined image on a display part;
a gaze detection part configured to detect a user's gaze;
a determination part configured to determine whether to perform unlocking, based on a plurality of setting positions set to the predetermined image and a gaze while the predetermined image is displayed; and
a calibration part configured to perform calibration of the gaze based on the gaze while the predetermined image is displayed.

2. The display control device according to claim 1, wherein the display controller displays a processed image provided by applying processing to the predetermined image, on the display part.

3. The display control device according to claim 2, wherein the processing includes at least processing to expand a partial or entire region of the predetermined image.

4. The display control device according to claim 3, wherein the processing includes at least processing to expand the partial or entire region of the predetermined image by seam carving.

5. The display control device according to claim 3, wherein the processing includes at least processing to cut off the partial region of the predetermined image.

6. The display control device according to claim 2, wherein the display controller displays a processed image provided by applying processing to the predetermined image according to a bias degree of the plurality of setting positions, on the display part.

7. The display control device according to claim 2, wherein the display controller displays a processed image provided by applying processing to the predetermined image according to a form of a display region of the predetermined image, on the display part.

8. The display control device according to claim 1, wherein the plurality of setting positions are set based on a position specified by the user's gaze or a user's operation in the predetermined image.

9. The display control device according to claim 8, wherein, when the position is specified in the predetermined image, the predetermined image is scrolled and displayed.

10. The display control device according to claim 1, wherein the determination part sequentially detects a plurality of gaze positions based on the gaze while the predetermined image is displayed, and, when corresponding positions in the plurality of gaze positions and the plurality of setting positions satisfy a predetermined relationship, determines to perform unlocking.

11. The display control device according to claim 10, wherein, when the corresponding positions in the plurality of gaze positions and the plurality of setting positions are matched or close, the determination part determined to perform unlocking.

12. The display control device according to claim 10, further comprising:
an output controller configured to output predetermined audio from an audio output part every time the gaze position is detected.

13. The display control device according to claim 1, wherein the gaze detection part detects the user's gaze based on an imaging result acquired by imaging the user's eye region.

14. The display control device according to claim 1, wherein the gaze detection part detects the user's gaze based on a direction of a head mount display (HMD) on the user's head.

15. The display control device according to claim 1, wherein the gaze detection part detects the user's gaze based on myoelectricity detected by a myoelectric sensor on a user's body.

16. A display control method comprising:
displaying a predetermined image on a display part;
detecting a user's gaze;
determining whether to perform unlocking, based on a plurality of setting positions set to the predetermined image and a gaze while the predetermined image is displayed; and
performing calibration of the gaze based on the gaze while the predetermined image is displayed.

17. A non-transitory computer-readable recording medium having a program recorded therein, the program causing a computer to function as a display control device comprising:
a display controller configured to display a predetermined image on a display part;
a gaze detection part configured to detect a user's gaze;
a determination part configured to determine whether to perform unlocking, based on a plurality of setting positions set to the predetermined image and a gaze while the predetermined image is displayed; and
a calibration part configured to perform calibration of the gaze based on the gaze while the predetermined image is displayed.
